(19) United States
(12) Patent Application Publication
(10) Pub. No.: US 2012/0325705 A1
(43) Pub. Date: Dec. 27, 2012

(54) TOOL BOX

(76) Inventor: Chieh-Lung CHEN, Taichung (TW)

(21) Appl. No.: 13/167,206

(22) Filed: Jun. 23, 2011

(51) Int. Cl. B25H 3/02

(52) U.S. Cl. 206/375; 206/349

(57) ABSTRACT

A tool box includes a base seat and an outer cover detachably capped on the base seat. The base seat includes a base block and a raised block disposed on a top end of the base block. Multiple sockets and an insertion cup are disposed on the raised block. The outer cover has an inner circumference and an outer circumference centered at an axis to define a chamber. The outer cover further has an annular bottom face and a top cap section connected with the inner and outer circumferences. The outer circumference has a polygonal cross section and is composed of multiple axial face sections. An axial anti-slip stripe is formed at a junction between each two adjacent axial face sections. When storing a screwdriver set, multiple screwdriver bits of the screwdriver set are respectively inserted in the sockets and a screwdriver handle is inserted in the insertion cup.

### BACKGROUND OF THE INVENTION

1. Field of the Invention

The present invention relates generally to a hand tool, and more particularly to a tool box.

2. Description of the Related Art

A screwdriver set is often used to tighten/untighten screws of various electrical appliances, furniture and toys, etc. in everyday life. The screwdriver set includes multiple screwdriver bits with different specifications and configurations. In case these screwdriver bits are not well stored in a tool box, missing of some of the screwdriver bits often takes place after a period of time. This will lead to trouble in later use.

### SUMMARY OF THE INVENTION

It is therefore a primary object of the present invention to provide a tool box for a user to conveniently store a screwdriver set. The user can more comfortably hold the tool box without slippage.

To achieve the above and other objects, the tool box of the present invention includes a base seat and an outer cover detachably capped on the base seat. The base seat includes a base block and a raised block disposed on a top end of the base block. Multiple sockets and an insertion cup are disposed on the raised block. The outer cover has an inner circumference and an outer circumference centered at an axis to define a chamber. The outer cover further has an annular bottom face and a top cap section connected with the inner and outer circumferences. The outer circumference has a polygonal cross section and is composed of multiple axial face sections connected with each other. An axial anti-slip stripe is formed at a junction between each two adjacent axial face sections.

The present invention is advantageous in that when storing a screwdriver set, multiple screwdriver bits of the screwdriver set are respectively inserted in the sockets and a screwdriver handle is inserted in the insertion cup. Accordingly, the screwdriver set can be conveniently stored. Thanks to the anti-slip stripes of the outer cover, a user can more securely hold the outer cover without slippage.

The present invention can be best understood through the following description and accompanying drawings, wherein:

### BRIEF DESCRIPTION OF THE DRAWINGS

FIG. 1 is a perspective assembled view of a preferred embodiment of the tool box of the present invention;

FIG. 2 is a perspective exploded view of the preferred embodiment of the tool box of the present invention, showing that the outer cover is opened;

FIG. 3 is a perspective exploded view of the preferred embodiment of the tool box of the present invention, showing the base seat, the locking unit and the screwdriver set;

FIG. 4 is a sectional assembled view of the preferred embodiment of the tool box of the present invention, in which the screwdriver set is removed; and

FIG. 5 is a sectional assembled view of the preferred embodiment of the tool box of the present invention, showing the positional relationship between the engagement block and the engagement channel.

### DETAILED DESCRIPTION OF THE PREFERRED EMBODIMENT

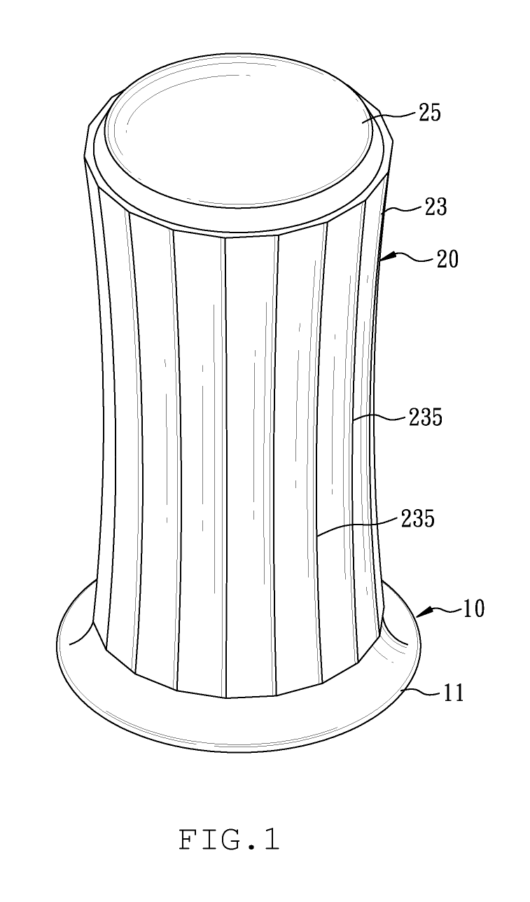

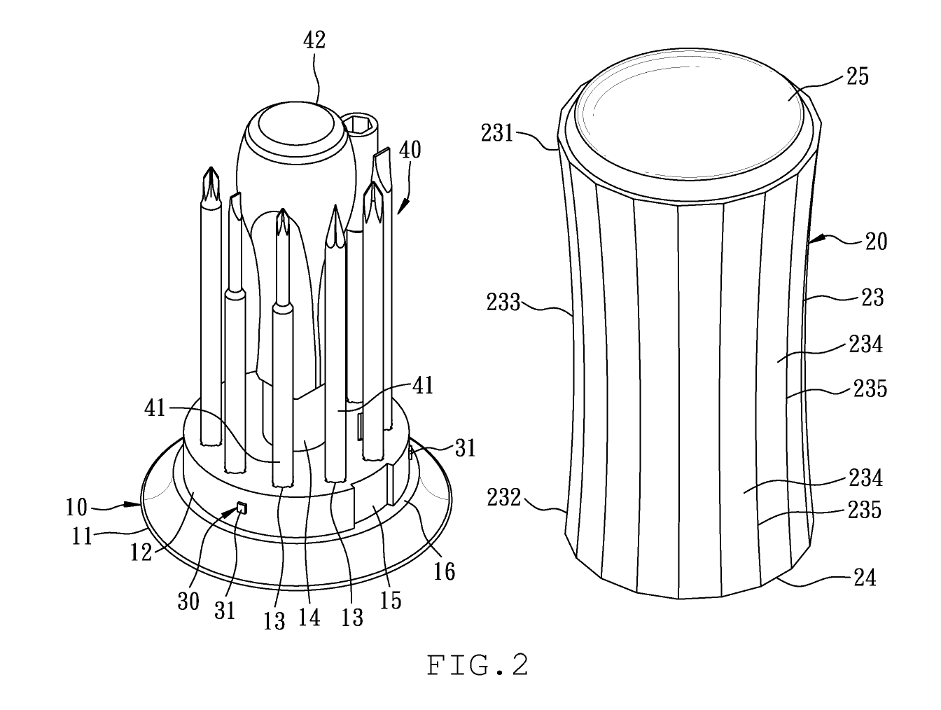

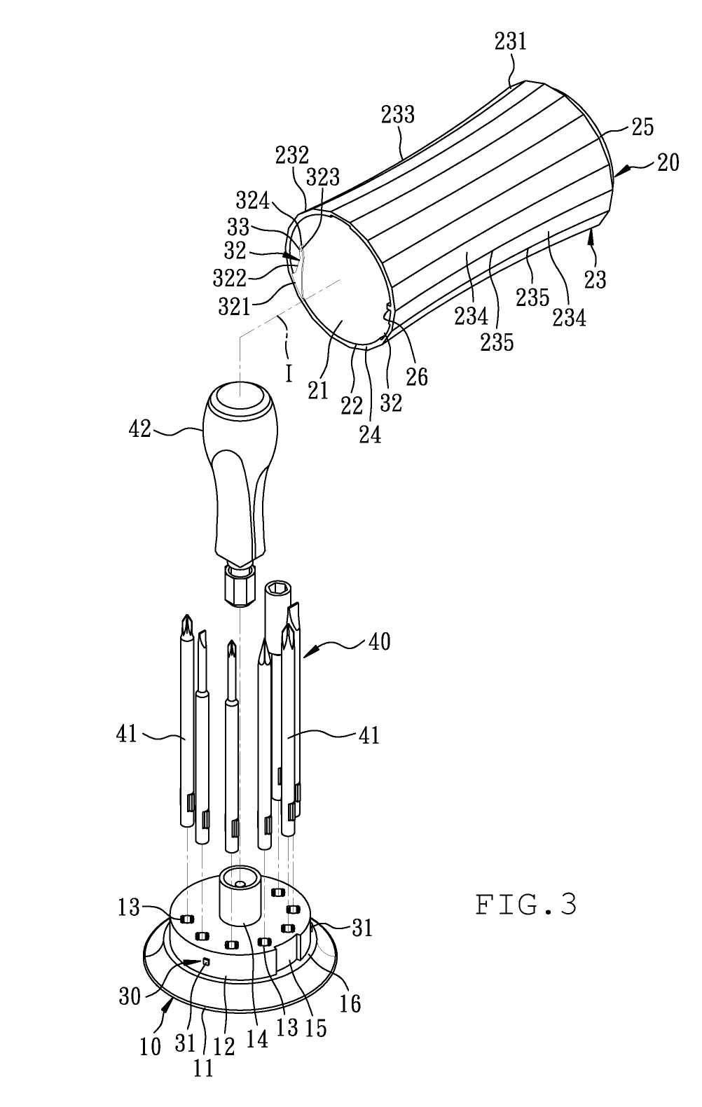

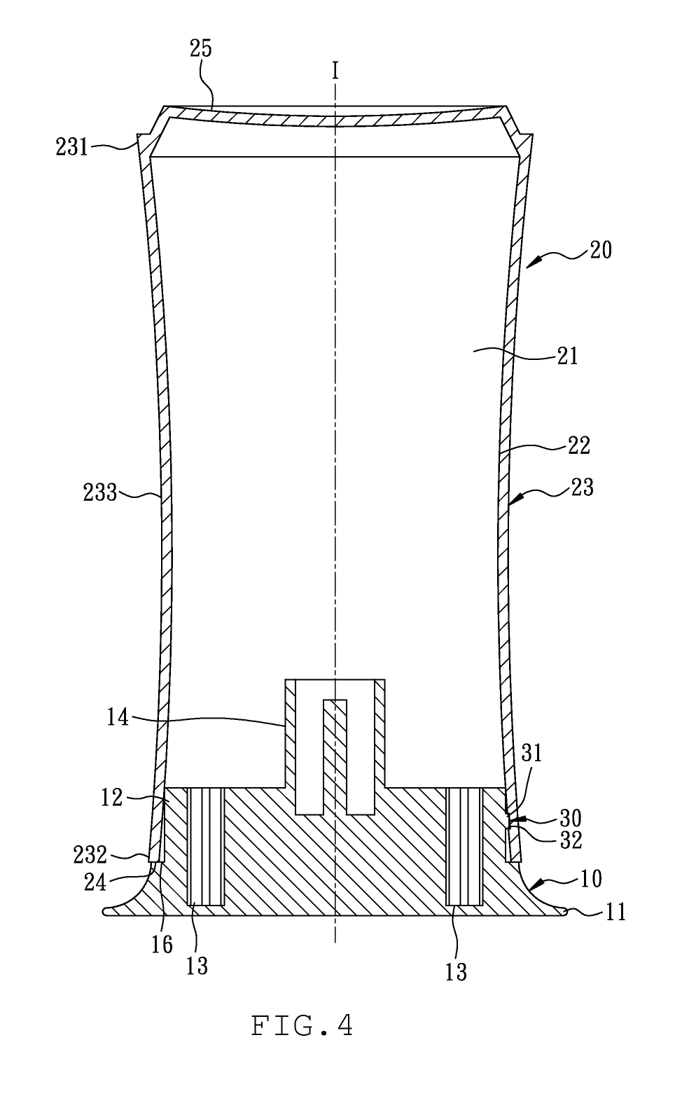

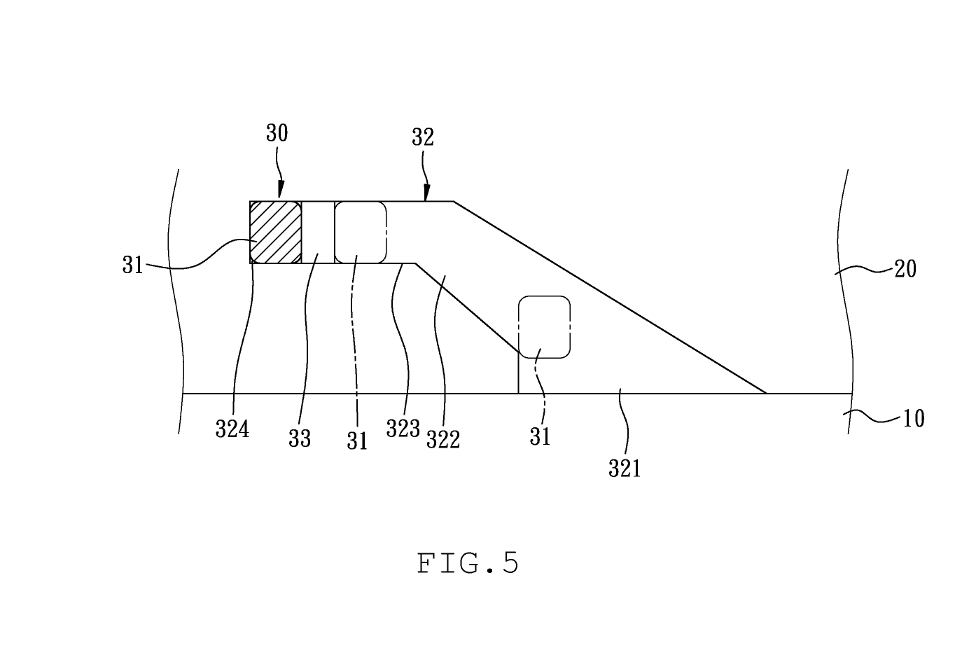

It should be first noted that the expressions to the relative positions in the specification, such as “top” and “bottom”, are given on the basis of the direction shown in the drawings and the direction in which the device is normally used. Please refer to FIGS. 1 to 5. According to a preferred embodiment, the tool box of the present invention includes a base seat 10, an outer cover 20, a locking unit 30 and a screwdriver set 40.

The base seat 10 includes a base block 11 tapered from a bottom end toward a top end of the base block 11 and a raised block 12 disposed on the top end of the base block 11. Multiple sockets 13 and an insertion cup 14 are disposed on the raised block 12. A recess 15 is formed on an outer circumference of the raised block 12. An annular shoulder section 16 is formed at a junction between the base block 11 and the raised block 12.

The outer cover 20 has an inner circumference 22 and an outer circumference 23 centered at an axis I to define a chamber 21. The outer cover 20 further has an annular bottom face 24 and a top cap section 25 connected with the inner and outer circumferences 22, 23. A rib 26 is formed on the inner circumference 22 corresponding to the recess 15.

The outer circumference 23 has a top end section 231, a bottom end section 232 and a middle waist section 233 gradually contracted from the top end section 231 and the bottom end section 232 to the middle. The outer circumference 23 has a polygonal cross section and is composed of multiple axial face sections 234 connected with each other. An axial anti-slip stripe 235 is formed at a junction between each two adjacent axial face sections 234.

The locking unit 30 includes at least one engagement block 31 disposed on the outer circumference of the raised block 12 and at least one engagement channel 32 formed on the inner circumference 22 of the outer cover 20 corresponding to the engagement block 31, and at least one stop block 33 disposed in the engagement channel 32.

The outer cover 20 can be securely locked with the base seat 10 by means of only one engagement block 31 and one engagement channel 32. In this embodiment, the tool box has three engagement blocks 31 and three engagement channels 32 as an example for illustration purposes only. The three engagement blocks 31 and three engagement channels 32 are arranged at equal angular intervals, whereby the outer cover 20 can be more securely locked with the base seat 10.

Each engagement channel 32 is divided into an opening section 321 in communication with the annular bottom face 24, a guide slope section 322 obliquely extending from the opening section 321 to the top end, and an engagement section 323 extending from the guide slope section 322 in parallel to the annular bottom face 24. The engagement section 323 has a closed end.

The stop block 33 is positioned in the engagement section 323. A terminal locating section 324 is defined between the closed end of the engagement section 323 and the stop block 33.

The screwdriver set 40 includes several screwdriver bits 41 and a screwdriver handle 42.

When storing the screwdriver set 40 in the tool box, the screwdriver bits 41 are respectively inserted into the sockets 13 of the base seat 10 and the screwdriver handle 42 is inserted into the insertion cup 14. Then the outer cover 20 is capped onto the base seat 10 to cover the screwdriver set 40. By means of rotating the outer cover 20 or the base seat 10, the engagement block 31 can be moved into the opening section 321 of the engagement channel 32 with the rib 26 positioned in the recess 15. Then the outer cover 20 or the base seat 10 is rotated to make the engagement block 31 move along the guide slope section 322 into the engagement section 323. Then the engagement block 31 passes over the stop block 33 and finally moves into the locating section 324. When a user rotates the outer cover 20 or the base seat 10, the user can feel the resistance against the movement of the engagement block 31 from the guide slope section 322 over the stop block 33 into the locating section 324. When the engagement block 31 enters the locating section 324, a click sound is produced and the outer cover 20 or the base seat 10 cannot be further rotated. Accordingly, the user can apparently feel that the outer cover 20 has been locked with the base seat 10. Under such circumstance, the annular bottom face 24 is positioned on the annular shoulder section 16 of the base seat 10 and it is impossible to freely open the outer cover 20. In this case, the user only needs to hold the outer cover 20 with one hand to conveniently carry or transfer the tool box of the present invention. In addition, thanks to the middle waist section 233 and the anti-slip stripes 235 of the outer cover 20, the user can more comfortably hold the outer cover 20 without slippage.

When it is desired to use the screwdriver set 40, the outer cover 20 or the base seat 10 is first rotated in reverse direction. At this time, the engagement block 31 moves from the locating section 324 over the stop block 33 to the guide slope section 322 and then to the opening section 321 to unlock the outer cover 20 from the base seat 10. Under such circumstance, the user only needs to hold the outer cover 20 with one hand and take off the outer cover 20 from the base seat 10 along the axis I to open the outer cover 20. Then a necessary screwdriver bit 41 and the screwdriver handle 42 are drawn out and assembled with each other to form a screwdriver for screwing/unscrewing a threaded member (not shown).

In conclusion, the tool box of the present invention has the following advantages:
1. The screwdriver bits 41 of the screwdriver set 40 are respectively inserted in the sockets 13 of the base seat 10 and the screwdriver handle 42 is inserted in the insertion cup 14 of the base seat 10. The outer cover 20 is capped on the base seat 10. Accordingly, the screwdriver set 40 can be conveniently stored without missing of any of the screwdriver bits 41.
2. Thanks to the middle waist section 233 and the anti-slip stripes 235 of the outer cover 20, the user can more comfortably hold the outer cover 20 without slippage.
3. The locking unit 30 is disposed between the outer cover 20 and the base seat 10 for securely locking the outer cover 20 with the base seat 10. Accordingly, a user can conveniently carry or transfer the tool box of the present invention.
4. The tool box of the present invention as a whole has a small volume and is easy to store and use.

The above embodiment is only used to illustrate the present invention, not intended to limit the scope thereof. Many modifications of the above embodiment can be made without departing from the spirit of the present invention.

1. A tool box comprising:
a base seat including a base block and a raised block disposed on a top end of the base block, multiple sockets and an insertion cup being disposed on the raised block;
an outer cover detachably capped on the base seat, the outer cover having an inner circumference and an outer circumference centered at an axis to define a chamber, the outer cover further having an annular bottom face and a top cap section connected with the inner and outer circumferences, the outer circumference having a polygonal cross section and being composed of multiple axial face sections connected with each other, an axial anti-slip stripe being formed at a junction between each two adjacent axial face sections.

2. The tool box as claimed in claim 1, wherein the outer circumference of the outer cover has a top end section, a bottom end section and a middle waist section gradually contracted from the top end section and the bottom end section to the middle.

3. The tool box as claimed in claim 2, further comprising a locking unit, the locking unit including at least one engagement block disposed on an outer circumference of the raised block and at least one engagement channel formed on the inner circumference of the outer cover corresponding to the engagement block, the engagement block being movable into the engagement channel.

4. The tool box as claimed in claim 3, wherein the number of the engagement blocks is three and the number of the engagement channels is also three, the three engagement blocks and three engagement channels being arranged at equal angular intervals.

5. The tool box as claimed in claim 4, wherein each engagement channel is divided into an opening section in communication with the annular bottom face, a guide slope section obliquely extending from the opening section to the top end, and an engagement section extending from the guide slope section in parallel to the annular bottom face, the engagement section having a closed end.

6. The tool box as claimed in claim 5, wherein the locking unit further includes three stop blocks respectively positioned in the engagement sections of the engagement channels, a terminal locating section being defined between the closed end of each engagement section and each stop block.

7. The tool box as claimed in claim 6, wherein a recess is formed on the outer circumference of the raised block of the base seat and a rib is formed on the inner circumference of the outer cover corresponding to the recess.

8. The tool box as claimed in claim 1, further comprising a screwdriver set including several screwdriver bits and a screwdriver handle, the screwdriver bits being respectively removably inserted in the sockets of the base seat and the screwdriver handle being removably inserted in the insertion cup of the base seat.
